(19) United States
(12) Patent Application Publication
(10) Pub. No.: US 2020/0128109 A1
(43) Pub. Date: Apr. 23, 2020

(54) METHOD FOR PERFORMING MODE TRANSITION OF COMPRESSION OPERATION IN TRANSMISSION DEVICE, AND TRANSMISSION DEVICE THEREOF

(71) Applicant: Realtek Semiconductor Corp., HsinChu (TW)

(72) Inventors: Chin Cheng, Taipei City (TW); Yixin Huang, Changshu City (CN); Runrun Wei, Wuxi City (CN)

(21) Appl. No.: 16/408,457

(22) Filed: May 9, 2019

(30) Foreign Application Priority Data
Oct. 23, 2018 (CN) 201811238505.6

(51) Int. Cl. H04L 29/06

(52) U.S. Cl. CPC H04L 69/04; H04L 65/608; H04L 69/164; H04L 69/22

(57) ABSTRACT

A method for performing mode transition of compression operation in a transmission device, and an associated transmission device, are provided. The compression operation includes a plurality of modes. The method includes: determining whether a module within the transmission device transforms a mode within the plurality of modes into another mode within the plurality of modes to transmit a set of context data; and when the module transforms the mode into said other mode to transmit the set of context data, transmitting other sets of context data that also belong to the module in said other mode, wherein the transmission device includes a compressor and a decompressor, and the module represents the compressor or the decompressor.

### BACKGROUND OF THE INVENTION

### 1. Field of the Invention

The present invention is related to compression operations, and more particularly, to a method for performing mode transition of a compression operation in a transmission device, and an associated transmission device.

### 2. Description of the Prior Art

In wired or wireless network applications, there are fixed data sets within multiple consecutive packets of a same data stream. In the related art, a device transmits this entire fixed data at the beginning of a data stream, so that only the changed portion needs to be transmitted in following packets of the data stream in order to compress the data and effectively utilize band resources of the wired or wireless network. The related art still has some problems, however. For example, robust header compression (RoHC) does not mention how to process multiple sets of context data in a same compressor or decompressor. In addition, for example, for a packet conforming to user data protocol (UDP), the mode transition might fail due to the lack of data or information. Thus, there is a need for a novel mode transition mechanism which can solve the aforementioned problems without introducing side effects or in a way that is less likely to introduce side effects.

### SUMMARY OF THE INVENTION

An objective of the present invention is to provide a method for performing mode transition of a compression operation in a transmission device, and an associated transmission device thereof, which can perform mode transition on a plurality of sets of context data in a same compressor or decompressor.

Another objective of the present invention is to provide a method for performing mode transition of a compression operation in a transmission device, and an associated transmission device thereof, which solves the problem of the related art wherein the mode transition fails due to the lack of data or information.

At least one embodiment of the present invention provides a method for performing mode transition of a compression operation in a transmission device, wherein the compression operation comprises a plurality of modes. The method comprises: determining whether a module within the transmission device transforms a mode within the plurality of modes into another mode within the plurality of modes to transmit a set of context data; and in response to the module transforming the mode into another mode to transmit the set of context data, transmitting other sets of context data that also belong to the module in the other mode, wherein the transmission device comprises a compressor and a decompressor, and the module represents the compressor or the decompressor.

At least one embodiment of the present invention provides a transmission device for performing mode transition according to the aforementioned method, wherein the transmission device comprises the compressor and the decompressor. The compressor is arranged to compress a header of a packet to be transmitted, and the decompressor is arranged to decompress a header of a received packet.

At least one embodiment of the present invention provides a method for performing mode transition of a compression operation in a transmission device, wherein the compression operation comprises a plurality of modes, and the method is applied in compression operations of multiple protocols of which a specific type of packets that are lack of data or information are needed in the mode transition (e.g. user datagram protocol (UDP)). The method comprises: checking whether a number of the specific type of multiple consecutive packets received by a decompressor within the transmission device from another transmission device reaches a predetermined value after a compressor within said other transmission device performs the mode transition; and in response to the number of the specific type of multiple consecutive packets reaching the predetermined value, performing the mode transition of the decompressor.

At least one embodiment of the present invention provides a transmission device for performing a mode transition according to the aforementioned method, wherein the transmission device comprises a compressor and the decompressor. The compressor is arranged to compress a header of the packet to be transmitted, and the decompressor is arranged to decompress a header of the received packet, wherein the received packet comprises any of the specific type of multiple consecutive packets.

The method of the present invention can perform mode transition on a plurality of sets of context data in a same compressor or decompressor. Additionally, the present invention can solve the problems of mode transition failing due to a lack of data or information. In addition, implementing the embodiments of the present invention will not greatly increase costs. Thus, the present invention can solve the problems of the related art without introducing side effects or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a transmission device transmitting a packet to another transmission device according to an embodiment of the present invention.

FIG. 2 illustrates detailed operations of a compressor and a decompressor performing robust header compression (RoHC) mode transition according to an embodiment of the present invention.

FIG. 3 illustrates detailed operations of a compressor and a decompressor performing RoHC mode transition according to an embodiment of the present invention.

### DETAILED DESCRIPTION

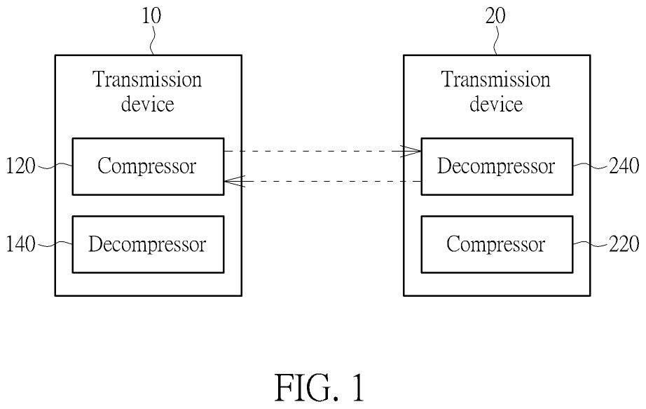

FIG. 1 is a diagram illustrating a transmission device 10 (such as a transmission device of a transmitter) transmitting a packet to a transmission device 20 (such as a transmission device of a receiver) according to an embodiment of the present invention. The transmission device 10 comprises a compressor 120 and a decompressor 140, and the transmission device 20 comprises a compressor 220 and a decompressor 240. In this embodiment, the compressor 120 may be arranged to compress a header of the packet and transmit the packet to the transmission device 20 (e.g. the decompressor 240), and the decompressor 240 may be arranged to decompress the header of the packet and transmit an associated confirmation signal to the transmission device 10 (e.g. the compressor 120), but the present invention is not limited thereto.

Robust header compression (RoHC) operations may comprise a plurality of modes such as a unidirectional (U) mode, an optimistic (O) mode, and a reliable (R) mode. In a data transmission process, the transmission device 10 and the transmission device 20 can perform mode transition between any two of the plurality of modes according to a current situation of the data transmission. Additionally, in a mode transition process, the mode transition may comprise three phases, comprising initiated (I) phase, pending (P) phase and done (D) phase, but the present invention is not limited thereto.

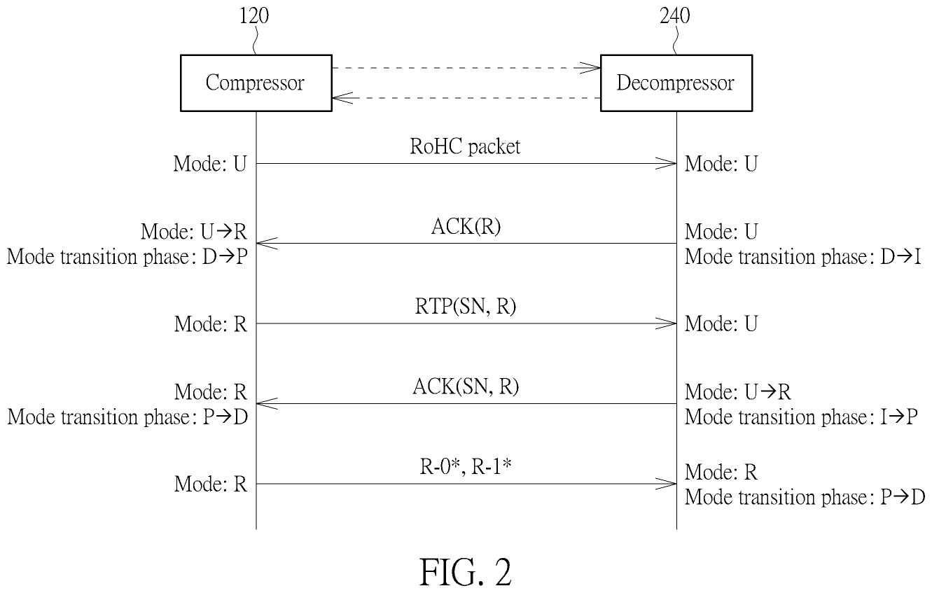

FIG. 2 illustrates detailed operations of the compressor 120 and the decompressor 240 performing the RoHC mode transition according to an embodiment of the present invention. In this embodiment, a transmission device (e.g. the transmission device 10 or the transmission device 20) may determine whether a module within the transmission device transforms a mode within the plurality of modes into another mode within the plurality of modes to transmit a set of context data. When the module transforms the mode (e.g. a mode A) into another mode (e.g. a mode B) to transmit the set of context data, the transmission device of the transmitter transmits other set (s) of context data that also belongs to the module in the mode B and the transmission device of the receiver decompresses other set (s) of context data in the mode A. For better comprehension, take a situation where the compressor 120 and the decompressor 240 transform into the R mode from the U mode as an example. At the beginning, the compressor 120 and the decompressor 240 both operate in the U mode, and the transmission device 10 may transmit a packet conforming to the RoHC specification (referred to as a RoHC packet for brevity) to the transmission device 20. After the decompressor 240 correctly decompresses the RoHC packet, the decompressor 240 may transmit a confirmation signal (e.g. an acknowledgement signal) ACK(R) in order to notify the compressor 120 that the RoHC packet has been correctly decompressed and indicate that the decompressor 240 requests to transform into the R mode, then the mode transition phase of the decompressor 240 may be transformed into the I phase from the D phase, where all context data that belong to the decompressor 240 are transmitted in a same mode, and the following steps within the mode transition this time are simultaneously performed on all context data. After the compressor 120 receives the confirmation signal ACK(R), the compressor 120 may transform an operation mode of the compressor 120 into the R mode from the U mode, and transform the mode transition phase thereof into the P phase from the D phase, where all context data that belong to the compressor 120 are transmitted in a same mode (such as the R mode), and the following steps within the mode transition this time are simultaneously performed on all context data. After the mode of the compressor 120 is transformed into the R mode, the compressor 120 may transmit a packet conforming to a real-time transport protocol (referred to as a RTP packet) to the decompressor 240, where the RTP packet carries mode information (e.g. the R mode) and a corresponding serial number SN, and is labeled RTP (SN, R). After the decompressor 240 correctly decompresses the aforementioned RTP packet, the decompressor 240 may transform an operation mode of the decompressor 240 into the R mode from the U mode, transform the mode transition phase into the P phase from the I phase, and the decompressor 240 then transmits a confirmation signal ACK(SN, R) to the compressor 120 in order to indicate that the operation mode of the decompressor 240 is the R mode. After the decompressor 120 receives the confirmation signal ACK(SN, R), the compressor 120 may transmit packets R-0* and/or R-1* to the decompressor 240 in order to make the decompressor 240 transform the mode transition phase into the D phase from the P phase, to finish the mode transition.

Similarly, multiple steps of other mode transitions (e.g. the U mode to the O mode, the R mode to the U mode, the R mode to the O mode, the O mode to the U mode, the O mode to the R mode) may be simultaneously performed on all context data belonging to the compressor 120 or the decompressor 240 according to the method of the present invention. Since those skilled in the art should understand implementation of the present invention method applied in other mode transitions after reading the above embodiments, related details are omitted for brevity.

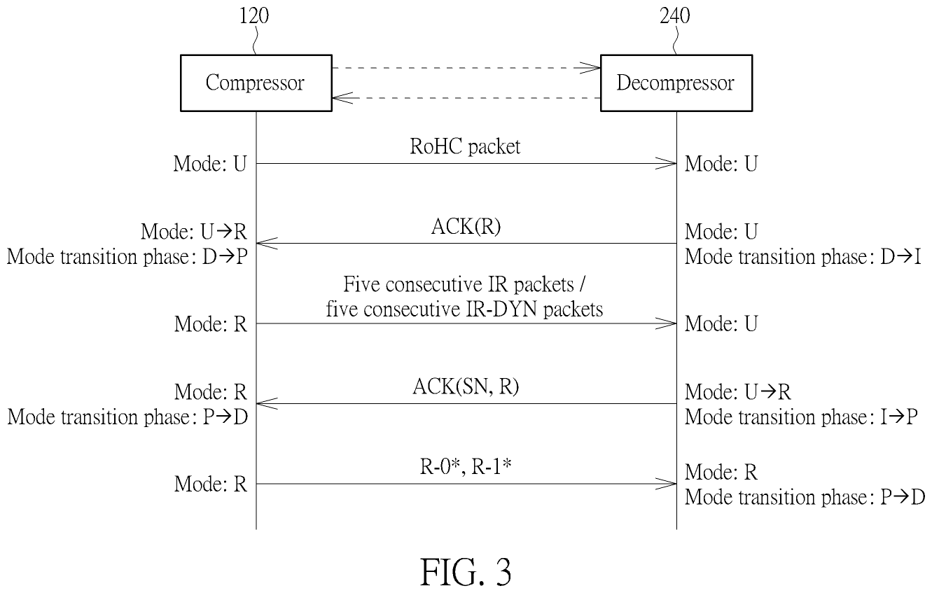

FIG. 3 illustrates detailed operations of the compressor 120 and the decompressor 240 performing RoHC mode transition according to an embodiment of the present invention. In comparison with the embodiment shown in FIG. 2, after the operation mode of the compressor 120 is transformed into the R mode from the U mode, the compressor 120 transmits a packet conforming to a user datagram protocol (referred to as an UDP packet for brevity) to the decompressor 240. In comparison with the aforementioned RTP packet, an initialization and Refresh (IR) packet or an IR packet without static information (IR-DYN packet) within the UDP packet does not comprise any field that is able to carry the mode information. Thus, when the compressor 120 cannot transmit a type-2 packet (referred to as a UOR-2 packet, which comprises field(s) that are able to carry the mode information) within the UDP packet, the decompressor 240 can determine whether to perform the mode transition of the decompressor 240 according to whether multiple consecutive IR packets or multiple consecutive IR-DYN packets are correctly decompressed. For example, after the compressor 120 performs the mode transition (e.g. transformed into the R mode), when the decompressor 240 receives a specific type of multiple consecutive packets without mode information (e.g. IR packets or IR-DYN packets) from the transmission device 10 (e.g. the compressor 120), the decompressor 240 may check whether the number of the specific type of multiple consecutive packets reaches a predetermined value (e.g. five). When the number of the specific type of multiple consecutive packets reaches the predetermined value (e.g. five consecutive IR packets or five consecutive IR-DYN packets), the decompressor 240 may transform the operation mode thereof into the R mode from the U mode in order to make the mode transition proceed. For brevity, repeated descriptions of the aforementioned embodiments are omitted here.

Similarly, regarding other mode transitions (e.g. the R mode to the U mode, the R mode to the O mode, the O mode to the U mode, and the O mode to the R mode, where the case of the U mode to O mode is not included in this embodiment), the decompressor 240 can check whether the number of the specific type of multiple consecutive packets reaches the predetermined value, to determine whether to proceed a corresponding mode transition. For example, different target modes may correspond to different predetermined values, but the present invention is not limited thereto. Since those skilled in the art should understand implementation of the present invention method applied in other mode transitions after reading the above embodiments, related details are omitted for brevity.

To summarize, the method of the present invention can perform mode transitions on a plurality of sets of context data in a same compressor or decompressor; for example, all context data that belong to the compressor 120 or all context data that belong to the decompressor 240. Additionally, the method of the present invention can solve the problems of mode transition failing due to lack of data or information. In addition, implementing the embodiments of the present invention will not greatly increase costs. Thus, the present invention can solve the problems of the related art without introducing side effects or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing mode transition of a compression operation in a transmission device, wherein the compression operation comprises a plurality of modes, and the method comprises:
determining whether a module within the transmission device transforms a mode within the plurality of modes into another mode within the plurality of modes to transmit a set of context data; and
in response to the module transforming the mode into said other mode to transmit the set of context data, transmitting other sets of context data that also belong to the module in said other mode, wherein the transmission device comprises a compressor and a decompressor, and the module represents the compressor or the decompressor.

2. The method of claim 1, wherein the compression operation is robust header compression (RoHC), and a set of context data that belongs to the compressor indicates a state utilized by the compressor for compressing a header, and a set of context data that belongs to the decompressor indicates a state utilized by the decompressor for decompressing a header.

3. The method of claim 2, wherein the plurality of modes comprise a unidirectional mode, an optimistic mode, and a reliable mode.

4. The transmission device for performing the mode transition according to the method of claim 2, wherein:
the compressor is arranged to compress a header of a packet to be transmitted; and
the decompressor is arranged to decompress a header of a received packet.

5. The transmission device of claim 4, wherein the plurality of modes comprise a unidirectional mode, an optimistic mode, and a reliable mode.

6. A method for performing mode transition of a compression operation in a transmission device, wherein the compression operation comprises a plurality of modes, the method is applied in compression operations of multiple protocols of which a specific type of packets that are lack of data or information are needed in the mode transition, and the method comprises:
checking whether the number of the specific type of multiple consecutive packets received by a decompressor within the transmission device from another transmission device reaches a predetermined value after a compressor within said another transmission device performs the mode transition; and
in response to the number of the specific type of multiple consecutive packets reaching the predetermined value, proceeding the mode transition of the decompressor.

7. The method of claim 6, wherein the multiple protocols comprises user datagram protocol (UDP).

8. The method of claim 6, wherein the compression operation is robust header compression (RoHC).

9. The method of claim 8, wherein the plurality of modes comprise a unidirectional (U) mode, an optimistic (O) mode, and a reliable (R) mode.

10. The method of claim 9, wherein the method is applicable to the mode transitions of O mode to R mode, U mode to R mode, R mode to O mode, O mode to U mode, and R mode to U mode.

11. The method of claim 8, wherein the specific type of multiple consecutive packets are multiple consecutive Initialization and Refresh (IR) packets or multiple consecutive IR packet without static information (IR-DYN).

12. The transmission device for performing the mode transition according to the method of claim 6, comprising:
a compressor, arranged to compress a header of a packet to be transmitted; and
the decompressor, arranged to decompress a header of a received packet, wherein the received packet comprises any of the specific type of multiple consecutive packets.

13. The transmission device of claim 12, wherein the compression operation is robust header compression (RoHC).

14. The transmission device of claim 13, wherein the plurality of modes comprise a unidirectional (U) mode, an optimistic (O) mode, and a reliable (R) mode.

15. The transmission device of claim 14, wherein the transmission device is applicable to the mode transitions of O mode to R mode, U mode to R mode, R mode to O mode, O mode to U mode, and R mode to U mode.

16. The transmission device of claim 13, wherein the specific type of multiple consecutive packets are multiple consecutive Initialization and Refresh (IR) packets or multiple consecutive IR packet without static information (IR-DYN).
